(19) United States
(12) Patent Application Publication
(10) Pub. No.: US 2005/0289454 A1
(43) Pub. Date: Dec. 29, 2005

(54) Interactive website configuration, display and management application

(75) Inventors: Joshua Donelson, Golden, CO (US); Wayne Donelson, Hixson, TN (US); Deanne B. Flanders, Hixson, TN (US)

Correspondence Address: WAYNE DONELSON;DEANNE & WAYNE & CO., 1923 HAMILL ROAD, HIXSON, TN, 37343, US

(73) Assignee: D & Wayne & co., Hixson, TN (US)

(21) Appl. No.: 10/698,997

(22) Filed: Jun. 28, 2004

(51) Int. Cl. G06F 17/24

(52) U.S. Cl. 715/513; 715/500

(57) ABSTRACT

The content of an interactive website is managed by an application comprising of two information systems. The visual system plays an interactive program which is dependent on and determined by the administrative system which provides access to various databases and allows the user to retrieve and configure the various components of the database into unique displays which can be viewed through activated commands. The function and complexity of the visual interactivity can be addressed and altered to display specific databases and configurations of databases which meet individual needs and requirements. Each component in the administrative system includes a configuration page describing the characteristics of the component when it is displayed and showing the database which is accessible by this component. The administrative system provides controls to manipulate the hierarchy of the visual elements. Each component of the final visual display is configured independently of the others and can be activated or deactivated in the administrative portion of the application according to the intended usage of the website and/or the daily visual display desired by the application manager. Databases are specific to individual components of the website and various users could require databases consistent with their independent website visuals. The application provides instructions and a template for creating and appending each database to conform with the users desired website visuals by deleting existing items or adding new items accessed from traditional desktop platforms. The application allows interpretation and expansion within the existing language enabling the continuous creation and processing of content. The web-based application dynamically reconfigures web-based databases to generate new page designs in the visual system commensurate with the host's access speed. Revised site views are accessible from control panels displayed continuously when operating in the administrative system. The administrative user can navigate between the visual system and all components of the administrative system by selecting component icons designated by pictures and words to eliminate error. The visual system can be accessed via a URL address and multiple users may access the application for multiple reasons at the same time. The administrative system which is accessed online is password protected to prevent unwanted changes to the visual system.

### FIELD OF THE INVENTION

The invention relates to website management and design. More specifically, the invention relates to creating and maintaining a website using a query language which pulls from databases to fill out the visual application.

This invention generally relates to website management. More specifically, the invention relates to methods and systems for changing the visual displays of websites and modifying the databases that are accessed for independent components of the website. Configuration scripts and databases are a combination of ASP, JAVA, and HTML programming. The invention provides a dynamic system to navigate and make both broad and detailed changes to the website as fast as the site can be accessed by the host.

### BACKGROUND OF THE INVENTION

The contents and visual display capabilities of websites are commonly managed by teams that are responsible for assimilating and configuring materials and then determining what and how pages will interact and be viewed. The dynamic functionality and constant, timely updating of databases necessary for many websites often requires changes to the core application design to achieve desired results and still maintain the dynamic nature of the site. Until now, these changes to core applications often required intervention by an application programmer. Even in the case of design-your-own-web-page-programs, changes are difficult for novice computer users to understand and implement and are severely limited in scope and visual control. Too often, changes that are seasonal or dated will need modification before the change can be made to the core application or rush charges are constantly incurred for keeping the website updated. In addition, changes needing application programming are expensive and often not cost effective. Maintaining large database files that need annual updating and purging is time sensitive and costly. To make these files even more difficult to manage, especially if they are images, it is imperative that they are formatted properly so as to load in the least amount of time on the browser's computer.

If more than one website can take advantage of a library of assembled image databases without having to include every image in its initial download size, then the user websites have a unique advantage. Moreover, if database image libraries can be updated, purged and expanded to provide the same database to multiple websites and multiple users on each website at one time, the overall costs to any one website can become much more affordable. The need exists for an application which can dynamically configure these databases.

Even for companies who hire web-savvy employees, caring and maintaining a large site is a tedious and time-consuming task. Changes that are feasible for most in-house personnel are limited to text and prices and a few pictures. These “data-entry” employees are not trained for site design, linking pages or information, adding and deleting files from the master files, or programming. Therefore, to have an online presence, many companies and individuals must compromise their needs and wants and settle for a few priorities displayed in a static web environment. Once produced, these sites are

### BACKGROUND OF THE INVENTION (continued)

likely to remain unchanged until they are outdated and stale. The overall look of the website and specifically the home page remain the same day after day, month after month, and year after year. Browsers who access the site are not likely to return more than once or twice after they see that the site is exactly the same as when they exited last. Because it is costly to add extensive image databases and because they take considerable time to download by many browsers, companies are forced to eliminate these preferred databases from their website.

For small companies and individuals on limited budgets, comprehensive websites and full-time web managers are out of the question. They do not know how to get started. Many look for local web designers or freelancers. They do not know how to ask for or define what they need in a web presence. They often settle for inferior sites that do not fulfill their needs or represent their business or products effectively. Unskilled and unprofessional web designers may not know how to create sites that are accessible from all browser formats. Moreover, poorly designed sites take too long to download by slow or antiquated telecommunication technologies. Non-technical programmers cannot combine several languages to achieve satisfactory results. Site owners are disappointed with results and may lose interest in pursuing internet business.

The difficulties of the web site management program are obvious and limited by both budget and training to all but the industry giants. As conventional businesses grow and expand, the web domain is limited in how much information and/or how many images can be accessed and organized for final presentation to the browser. This dilemma leads us to the logical conclusion that big companies will be much more effective on the internet in contrast to the belief that the internet gives small internet users equal opportunity for success.

In view of the foregoing, it is clear that a considerable need exists for an application that is both dynamic and multi-functional, one that can be configured into either a large or small website which can be efficiently and effectively maintained by a non-technical person. The usefulness of this application is further enhanced if the application can configure as many databases as required as long as the host website is sufficient to the task. A website management program that can significantly reduce the size of the downloading files by making multiple external files accessible to slow browsers will improve the vitality of the website as ultimately presented to a user.

### SUMMARY OF THE INVENTION

The content of an interactive website is managed by an application comprising two information systems. The visual system plays an interactive program which is dependent on and determined by the administrative system which provides access to various databases and allows the user to retrieve and configure the various components of the database into unique displays which can be viewed through activated commands. The function and complexity of the visual interactivity can be addressed and altered

### SUMMARY OF THE INVENTION (continued)

to display specific databases and configurations of databases which meet individual needs and requirements. Each component in the administrative system includes a configuration page describing the characteristics of the component when it is displayed and showing the database which is accessible by this component. The administrative system provides controls to manipulate the hierarchy of the visual elements. Each component of the final visual display is configured independently of the others and can be activated or deactivated in the administrative portion of the application according to the intended usage of the website and/or the daily visual display desired by the application manager. Databases are specific to individual components of the website and various application managers could require databases consistent with their individual desired website visuals. The application provides instructions and a template for creating and appending each database to conform to the user's desired website visuals by deleting existing items or adding new items accessed from traditional desktop platforms. The application allows interpretation and expansion within the existing language enabling the continuous creation and processing of content. The web-based application dynamically reconfigures web-based data-bases to generate new page designs in the visual system commensurate with the host's access speed. Revised site views are accessible from control panels displayed continuously when operating in the administrative system. The administrative user can navigate between the visual system and all components of the administrative system by selecting component icons designated by both pictures and words to eliminate error. The visual system can also be accessed via a URL address and multiple users may access the application for multiple reasons at the same time. The administrative system which is accessed online is password protected to prevent unwanted changes to the visual system.

A second purpose for this invention is to provide one program that can be expanded as the need arises without having to start over from scratch and without having to reprogram any of the fundamental portions of the website. This invention allows the user to launch a very basic site and move into full e-commerce as internet experience and business dictate. Control panels that configure applicable databases are activated in real time.

Further, the object of this invention is to allow a non-technical person to make real-time changes to a website from an in-house situation. Previously, it may have taken an application developer or a trained computer technician hours or days to implement basic changes to display and database content and configuration.

In addition, multiple external files can be accessible to the application program. These external files might include databases assembled for use by multiple websites that need periodic modifications, files that, because of size or cost, would preclude a normal web development program from using them.

With these and other advantages and features of the invention that will become hereinafter apparent, the nature of the invention may be more clearly understood by the reference to the following detailed description of the invention, the appended claims and to the several drawings attached herein.

### BRIEF DESCRIPTION OF THE DRAWINGS

FIG. 1 is a flow chart generally illustrating a first embodiment for carrying out the present invention.

FIG. 2 is a flow chart generally illustrating a second embodiment for carrying out the present invention.

FIG. 3 is a flow chart generally illustrating a third embodiment for carrying out the present invention.

FIG. 4 shows a screen from a dynamic view of overview of administration system.

FIG. 5 shows a screen from a dynamic view administration page which determines hierarchy of visual elements as described in FIG. 2.

FIG. 6 shows a screen from a dynamic view configuration document for online databases as described in FIG. 3.

FIG. 7 shows a screen from a dynamic view configuration document showing dynamic save function on administration system.

FIG. 8 shows a screen from a dynamic view control panel showing dynamic “view website” on administration system.

FIG. 9 shows a screen from a dynamic view of configuration page on administration system showing modifications.

FIG. 10 shows a screen from a dynamic view of activated website page after it has been configured on administration system.

### DETAILED DESCRIPTION OF THE PREFERRED EMBODIMENTS

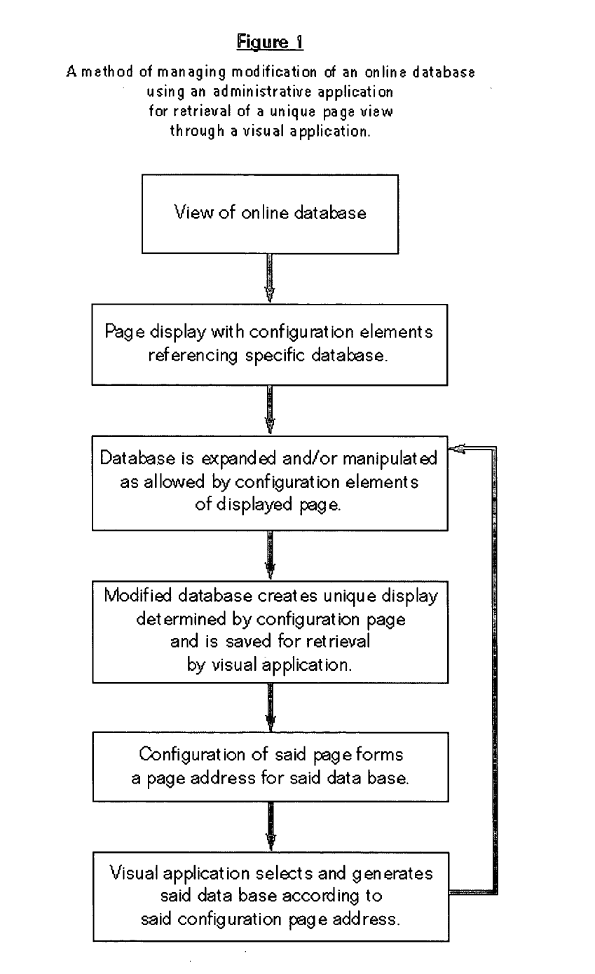

With reference to FIG. 1, the present invention relates to a method of displaying the content of an interactive website managed by an application consisting of two information systems . . . a visual system and an administrative system. The visual system plays an interactive program which is dependent on and determined by the administrative system which provides access to various databases and allows the user to retrieve and configure the various components of the database into unique displays which can be viewed through activated commands. The function and complexity of the visual interactivity can be addressed and altered to display specific databases and configurations of databases which meet individual needs and requirements. Each component in the administrative system includes a configuration page describing the characteristics of the component when it is displayed and showing the database which is accessible by this component. The application manager can review the current database; make additions or deletions to the database, and save the revised database as the preferred online database for this component on the same configuration page. Without leaving the configuration page, the application manager can select a link to dynamically view the revised online visual display relating to the configuration page just modified. If he is not satisfied with the results, he can immediately make additional changes to the database, save them and again view the modified visual display. When all modifications are made, the application manager can exit the administrative program or choose another component to modify.

### DETAILED DESCRIPTION OF THE PREFERRED EMBODIMENTS (continued)

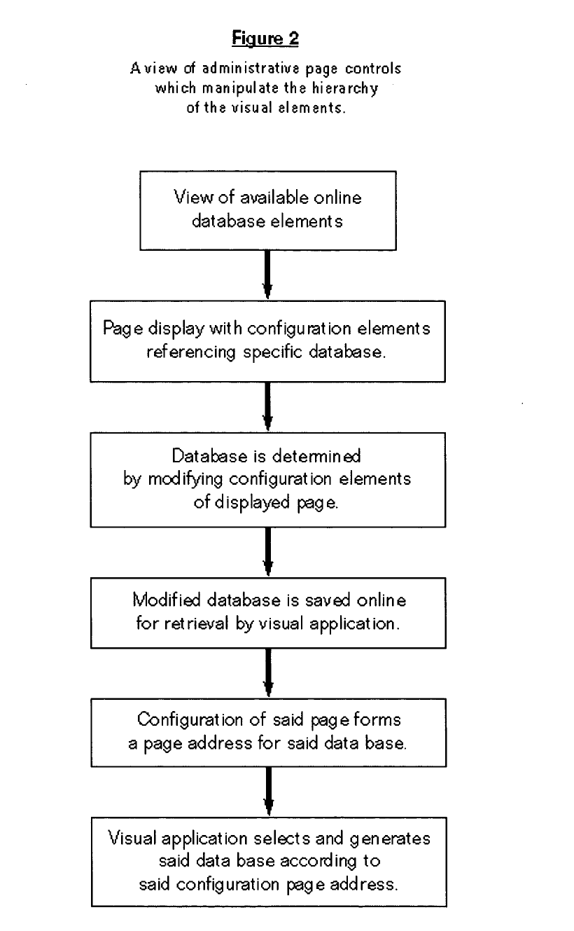

With reference to FIG. 2, the present invention demonstrates administrative system controls to manipulate the hierarchy of the visual elements. Heretofore, changing menu titles and/or revising which menu selections are active and visible on a website on any given day was usually a job for a skilled web programmer. The present invention allows each component of the final visual display to be configured independently of the others and to be activated or deactivated in the administrative portion of the application according to the intended usage of the website and/or the daily visual display desired by the application manager. Databases are specific to individual components of the website and various users could require databases consistent with their independent desired website visuals. The preferred embodiment of the invention provides the administrative manager, who has only minimal computer skills, unlimited versatility in making daily modifications to the interactive visual system by simply altering databases in the administrative system.

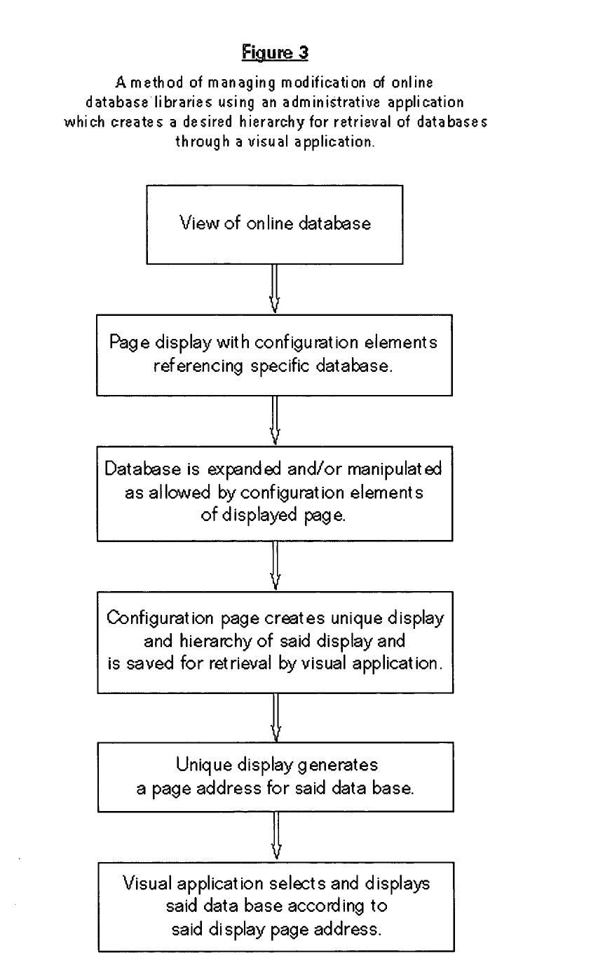

In FIG. 3, the preferred embodiment of the application provides instructions and a template for creating and appending each database to conform with the users desired website visuals by deleting existing items or adding new items accessed from traditional desktop platforms. Manipulation of images is particularly difficult for unskilled web designers as download times for web browsers are directly proportional to the size and number of files. Detailed instructions for creating efficient files are nested with access to appropriate online databases. Configurations are specifically written to minimize download times. The application allows interpretation and expansion within the existing language enabling the continuous creation and processing of content.

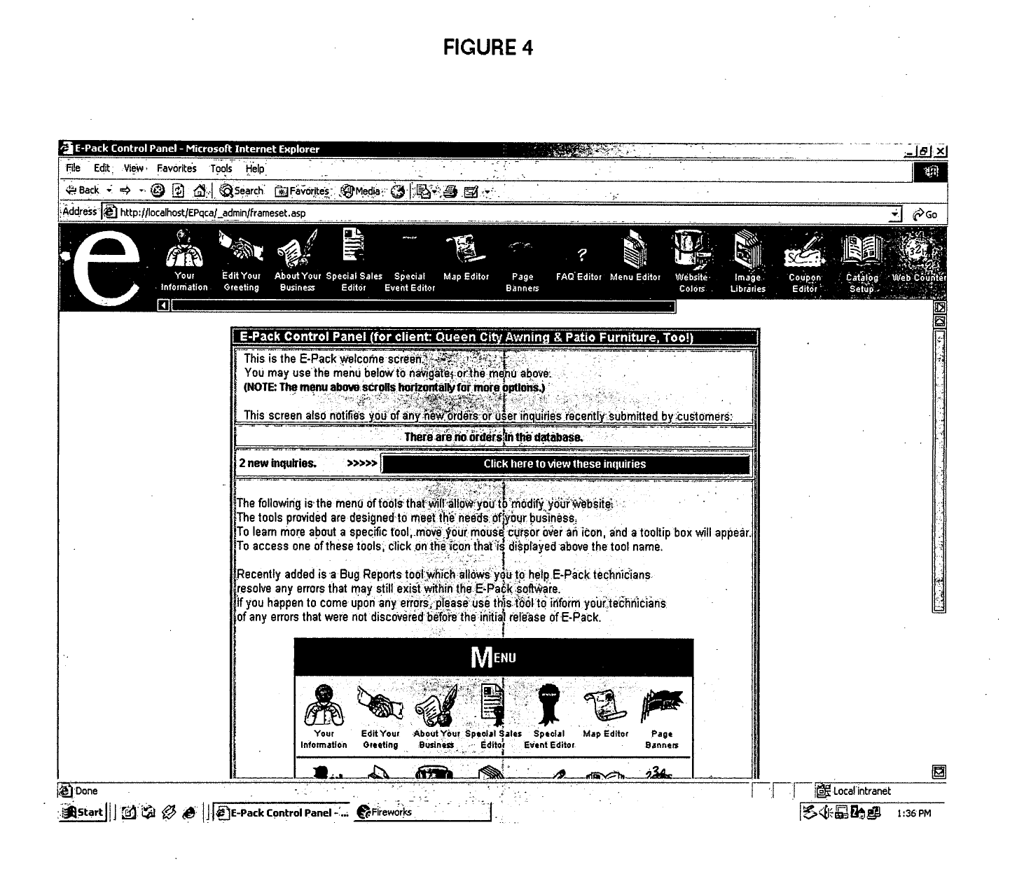

In FIG. 4, the screen shows a dynamic view of the overview of the administration system illustrating multiple icons that can be dynamically sourced for making changes to the online databases.

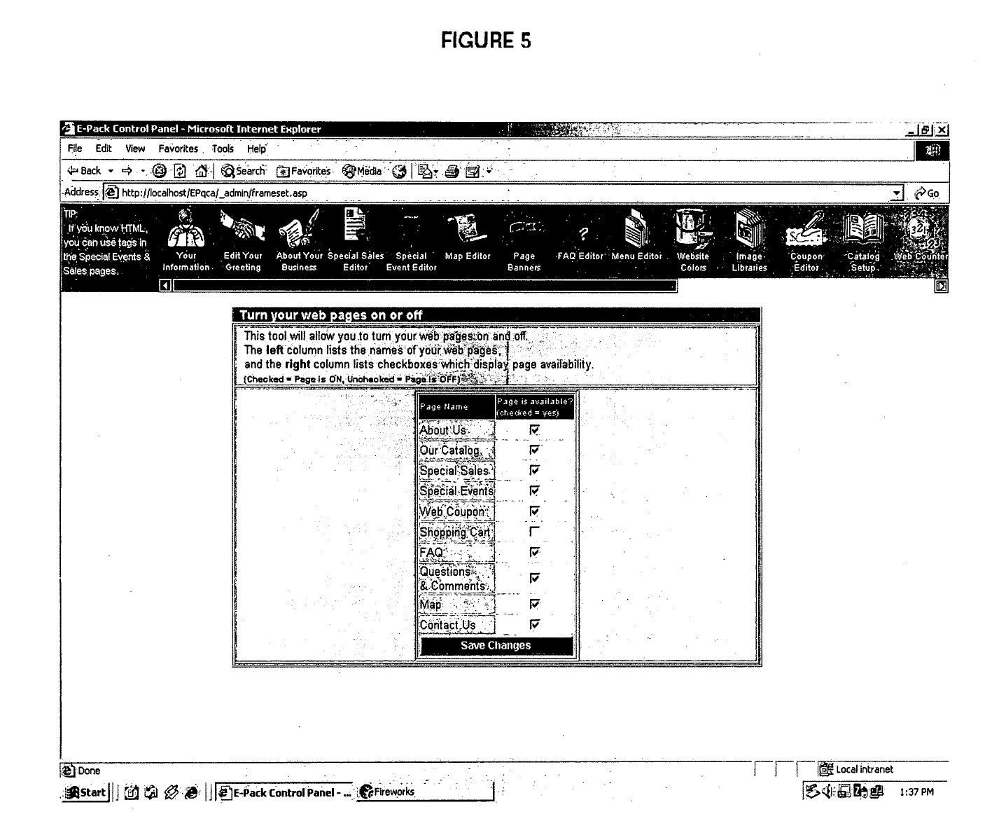

In FIG. 5, the screen shows a dynamic view hierarchy modification accessed through the administration system.

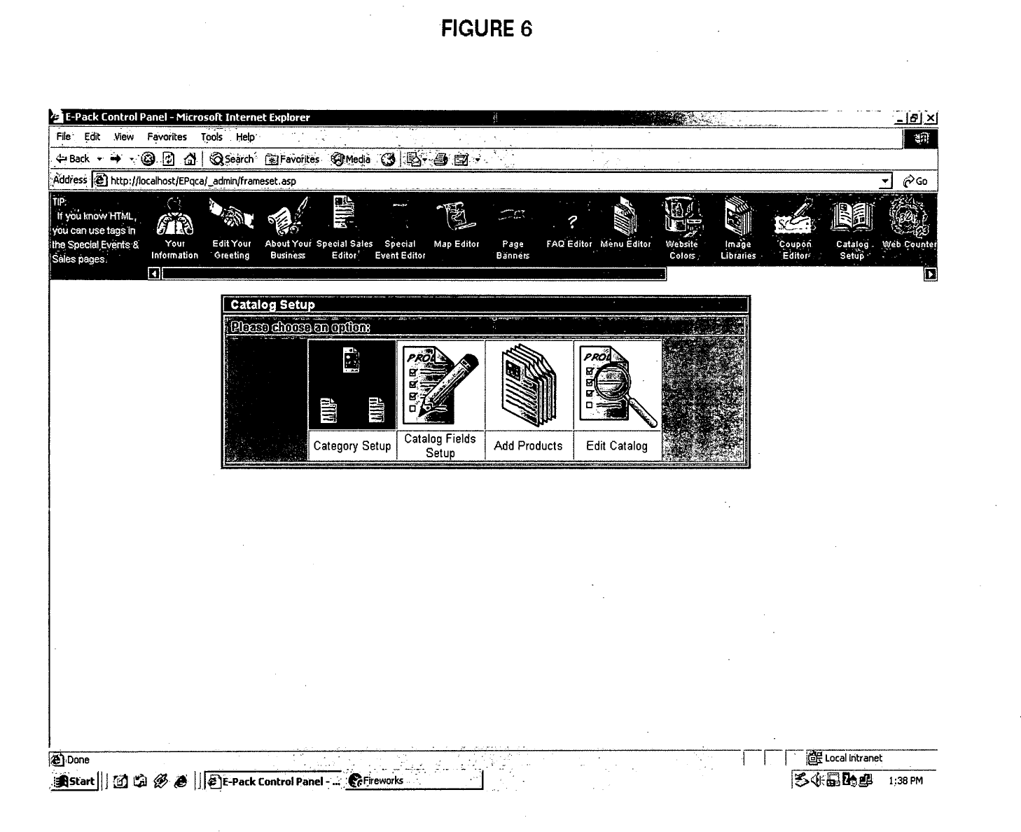

In FIG. 6, the screen shows a dynamic view configuration document which provides instructions and a template for creating and appending each database to conform to the users desired website visuals by deleting existing items or adding new items accessed from traditional desktop platforms.

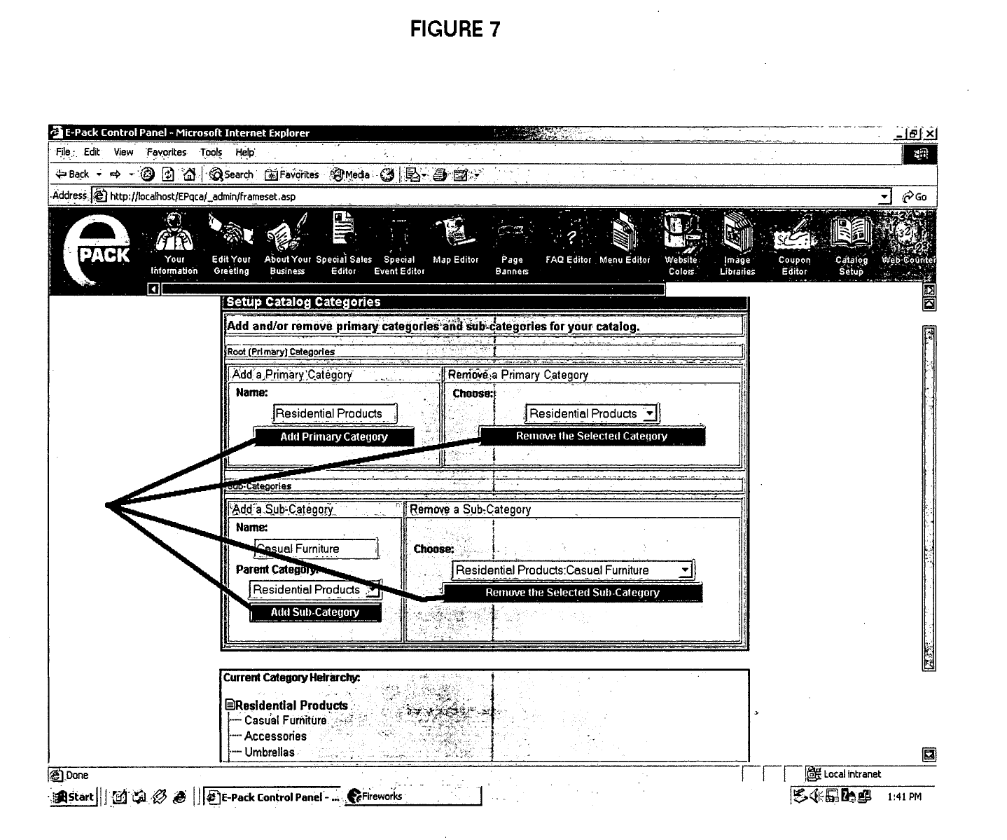

In FIG. 7, the screen shows a dynamic view configuration showing how the web-based application and web-based databases can be reconfigured to generate new page designs in the visual system commensurate with the host's access speed.

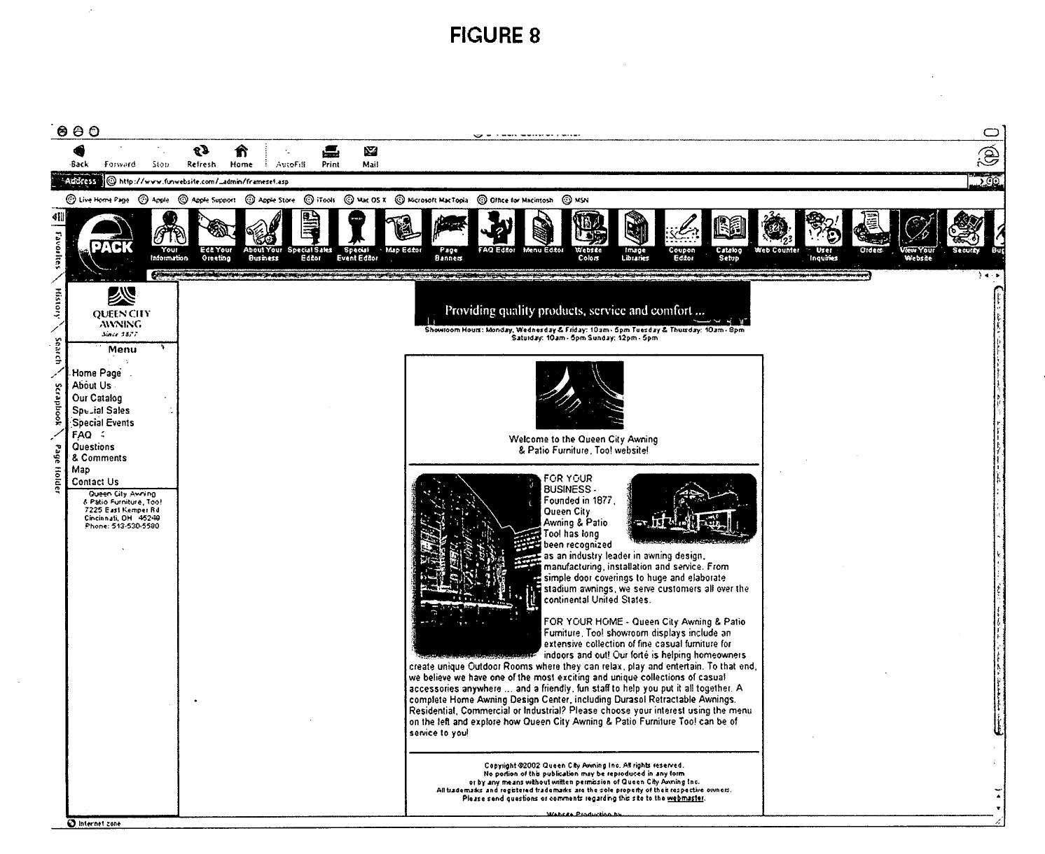

In FIG. 8, the screen shows a dynamic view configuration showing an administration page which makes revised site views accessible from control panels which are displayed continuously when operating in the administrative system. The administrative user can navigate between the visual system and all components of the administrative system by selecting component icons designated by pictures and words to eliminate error.

### DETAILED DESCRIPTION OF THE PREFERRED EMBODIMENTS (continued)

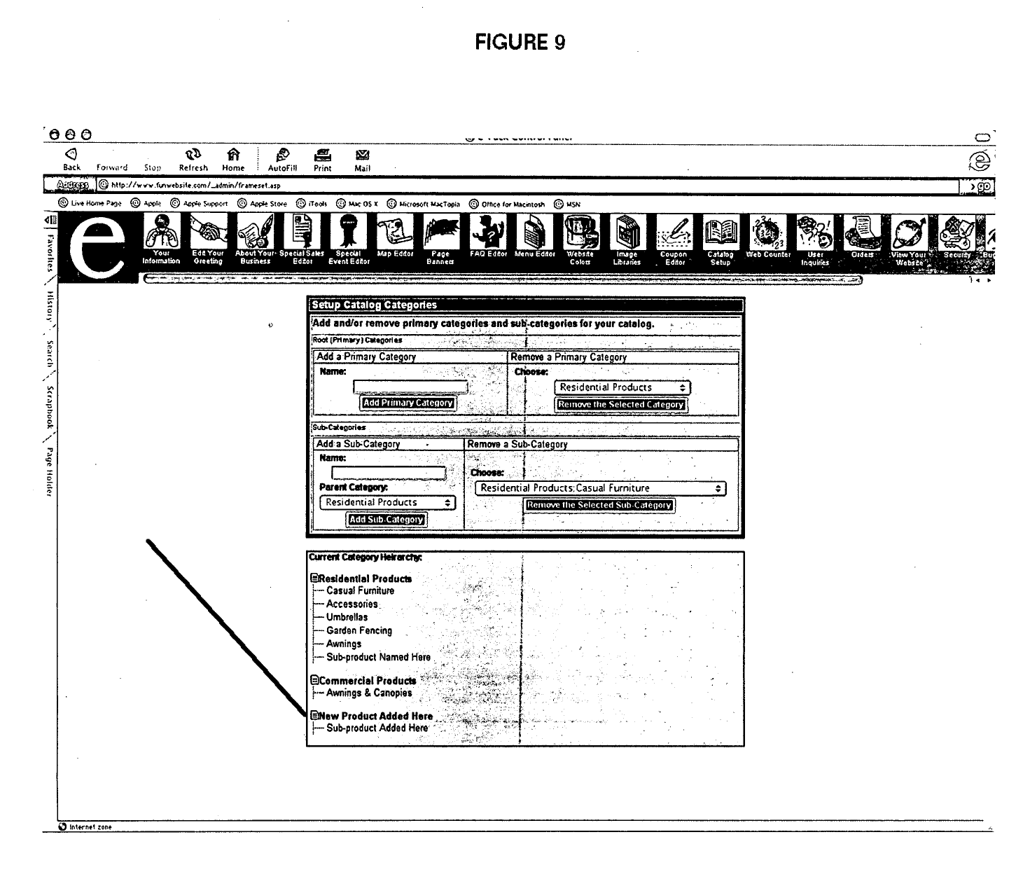

In FIG. 9, the screen shows a dynamic view of the visual system accessed via a desktop browser.

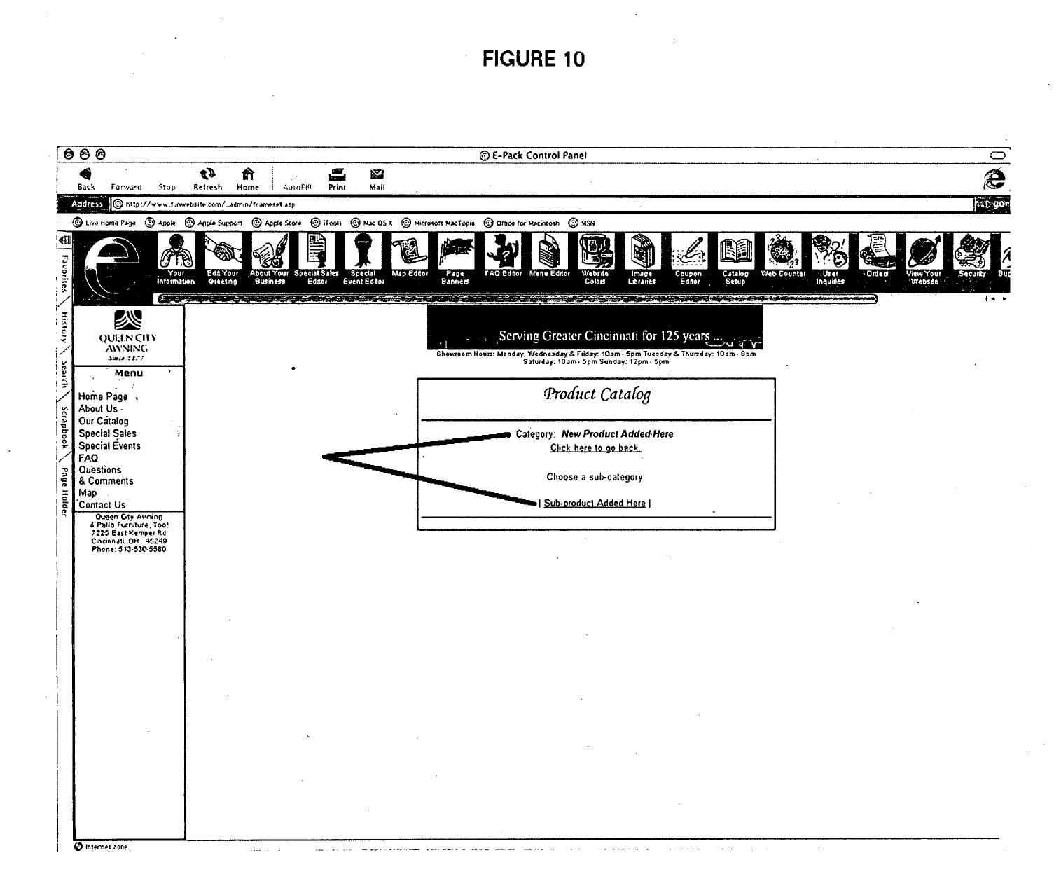

In FIG. 10, the screen shows a dynamic view of the visual system accessed via a desktop browser after a modification of the databases.

1. A method of creating web pages of unique displays of data retrieved from web-based databases, comprising the steps of:
providing through a hidden administrative function a view of multiple databases from which distinct elements can be accessed for display or disabled from display;
providing in each said database a configuration document describing the characteristics of said page when displayed;
providing a configuration document for the addition and deletion of distinct elements within certain databases;
providing a document for reconfiguration of distinct elements within certain databases;
providing within each of the multiple databases a view of the distinct elements which comprise that database;
providing in said database a form for reading said configuration or reconfiguration document, for retrieving selected data from said view, and placing said data on said page as described by the document;
forming a page address from the names of said database and said form; and
selecting said page address to display said data on said page.

2. A method according to claim 1, of providing both icons and words representing each of the configuration documents and an icon/words representing the URL address on the internet which displays the configured pages, and wherein the selection of an icon accesses the appropriate configuration document or the URL address. (In remaining text, icon=icons and words.)

3. A method according to claim 2, of further comprising the step of accessing the configuration document or the URL address, and wherein the step of providing the icons/words includes the step of providing all the icons/words when the page is accessed.

4. A method according to claim 1, wherein the view for a particular icon may include one or several data sets and the configuration document includes several instruction sets for the displaying of data on the page, and further including the steps of selecting one of the data sets and one of the instruction sets, and displaying the selected data set on said page in accordance with the selected instruction set.

5. A method according to claim 4, of providing instruction sets for the addition and deletion of distinct elements within data sets accessed by the icon, and further, making addition or subtraction of new items accessible from traditional desktop platforms.

6. A method according to claim 4, of providing instruction sets for the reconfiguration of data sets accessed by the icon.

7. A method according to claim 4, of providing instruction sets for the manipulation of the hierarchy of the database displays.

8. A method according to claim 4, of providing means for creating, replacing or updating pages and displays to the associated URL website on demand.

9. A method according to claim 2, of providing an icon which when selected will access the URL address on the internet that displays the pages configured for display by the administrative function.

10. A system for displaying data on an active URL website in various page configurations which are served on demand at a speed commiserate to the ISP connection speed, comprising:
a multitude of databases including a view having data therein; a configuration or reconfiguration document describes the characteristics of the page determined by the database; a form for reading said configuration or reconfiguration document, for retrieving data from said view and arranging said data on said page as described by the configuration or reconfiguration document;
means for restructuring and manipulating the hierarchy of the database displays;
means for forming a page address from the names of said database and said form;
means for selecting the said page address to display data on said page;
means for updating pages and displays to the associated URL website.

11. A system according to claim 2, further comprising means for providing both icons and words for locating configuration documents.

12. A system according to claim 3, of further comprising the step of accessing the configuration document or the URL address, and wherein the step of providing the icons/words includes the step of providing all the icons/words when the page is accessed.

13. A system according to claim 4, wherein the view for a particular icon may include one or several data sets and the configuration document includes several instruction sets for the displaying of data on the page, and further including the steps of selecting one of the data sets and one of the instruction sets, and displaying the selected data set on said page in accordance with the selected instruction set.

14. A method according to claim 5, of providing instruction sets for the addition and deletion of distinct elements within data sets accessed by the icon, and further, making addition or subtraction of new items accessible from traditional desktop platforms.

15. A method according to claim 5, of providing instruction sets for the reconfiguration of data sets accessed by the icon.

16. A system according to claim 5, of providing instruction sets for the manipulation of the hierarchy of the database displays.

17. A system according to claim 5, of providing means for creating, replacing or updating pages and displays to the associated URL website.

18. A system according to claim 9, of providing an icon which when selected will access the URL address on the internet that displays the pages configured for display by the administrative function.

19. A program storage device readable by machine, tangibly embodying a program of instructions executable by the machine to perform method steps for displaying data from a database onto a page, said method steps comprising:
providing through a hidden administrative function a view of multiple databases from which distinct elements can be accessed for display or disabled from display;
providing in each said database a configuration document describing the characteristics of said page when displayed;
providing a configuration document for the addition and deletion of distinct elements within certain databases;
providing a document for reconfiguration of distinct elements within certain databases;
providing within each of the multiple databases a view of the distinct elements which comprise that database;
providing in said database a form for reading said configuration or reconfiguration document, for retrieving selected data from said view, and placing said data on said page as described by the document;
forming a page address from the names of said database and said form; and
selecting said page address to display said data on said page.

20. A program storage device according to claim 19, of providing both icons and words representing each of the configuration documents and an icon/words representing the URL address on the internet which displays the configured pages, and wherein the selection of an icon accesses the appropriate configuration document or the URL address.

21. A program storage device according to claim 20, of further comprising the step of accessing the configuration document or the URL address, and wherein the step of providing the icons/words includes the step of providing all the icons/words when the page is accessed.

22. A program storage device according to claim 19, wherein the view for a particular icon may include one or several data sets and the configuration document includes several instruction sets for the displaying of data on the page, and further including the steps of selecting one of the data sets and one of the instruction sets, and displaying the selected data set on said page in accordance with the selected instruction set.

23. A program storage device according to claim 20, of providing instruction sets for the addition and deletion of distinct elements within data sets accessed by the icon, and further, making addition or subtraction of new items accessible from traditional desktop platforms.

24. A program storage device according to claim 20, of providing instruction sets for the reconfiguration of data sets accessed by the icon.

25. A program storage device according to claim 20, of providing instruction sets for the manipulation of the hierarchy of the database displays.

26. A program storage device according to claim 20, of providing means for creating, replacing or updating pages and displays to the associated URL website.

27. A program storage device according to claim 20, of providing an icon which when selected will access the URL address on the internet that displays the pages configured for display by the administrative function.

28. A program storage device according to claim 19, of providing both icons and words representing each of the configuration documents and an icon/words representing the URL address on the internet which displays the configured pages, and wherein the selection of an icon accesses the appropriate configuration document or the URL address.

21. A program storage device according to claim 20, of further comprising the step of accessing the configuration document or the URL address, and wherein the step of providing the icons/words includes the step of providing all the icons/words when the page is accessed.

22. A program storage device according to claim 19, wherein the view for a particular icon may include one or several data sets and the configuration document includes several instruction sets for the displaying of data on the page, and further including the steps of selecting one of the data sets and one of the instruction sets, and displaying the selected data set on said page in accordance with the selected instruction set.

23. A program storage device according to claim 20, of providing instruction sets for the addition and deletion of distinct elements within data sets accessed by the icon, and further, making addition or subtraction of new items accessible from traditional desktop platforms.

24. A program storage device according to claim 20, of providing instruction sets for the reconfiguration of data sets accessed by the icon.

25. A program storage device according to claim 20, of providing instruction sets for the manipulation of the hierarchy of the database displays.

26. A program storage device according to claim 20, of providing means for creating, replacing or updating pages and displays to the associated URL website.

27. A program storage device according to claim 20, of providing an icon which when selected will access the URL address on the internet that displays the pages configured for display by the administrative function.
